(19) United States
(12) Patent Application Publication
(10) Pub. No.: US 2012/0247663 A1
(43) Pub. Date: Oct. 4, 2012

(54) SLIP-PROOF TILE MANUFACTURING METHOD

(76) Inventor: Pen-Yuan CHEN, New Taipei City (TW)

(21) Appl. No.: 13/185,186

(22) Filed: Jul. 18, 2011

(30) Foreign Application Priority Data
Mar. 31, 2011 (TW) 100111235

(51) Int. Cl. B29C 43/20

(52) U.S. Cl. 156/276

(57) ABSTRACT

A slip-proof tile manufacturing method, comprising following steps: stacking sequentially from bottom to top a bottom layer having a plurality of first mineral particles; a decoration layer; and an enhanced wear-resistance layer having a plurality of second mineral particles, such that the second mineral particles are exposed out of a top surface of the enhanced wear-resistance layer; and forming a laminating wear-resistance layer having a plurality of third mineral particles on the top surface of the enhanced wear-resistance layer, so as to embed the exposed second mineral particles, so that the third mineral particles are distributed evenly inside and on the top surface of the laminating wear-resistance layer, hereby realizing said slip-proof tile. The slip-proof tile thus produced having the characteristics of high wear-resistance, scratch-resistance, and high slip-proof.

### BACKGROUND OF THE INVENTION

1. Field of the Invention

The present invention relates to a tile manufacturing method, and in particular to a slip-proof tile manufacturing method.

2. The Prior Arts

In recent years, due to indoor decoration and floor clearance convenience, therefore, it is quite common to place floor tile on the ground as required. In general, a tile is mainly made of ceramics or plastic (PVC), such that its price can be varied depending on the material it is made.

Presently, the slip-proof capability of a conventional tile is not quite satisfactory, thus people walking on it is liable to slip and fall down, and that is especially dangerous when the floor of the ground is wet. In the prior art, the conventional tile can only provide ordinary surface slip-proof capability, and its finished product is as shown in FIG. 1, such that the surface of a tile 10 is provided with a roughened layer 12 containing coarse particles. Though this kind of surface is capable of providing frictions and slip-proof capability, yet under repeated usage and frequent walking thereon by people, this layer tends to be worn out and could be detached from the tiles 10, hereby causing considerable inconvenience for the users.

Therefore, presently, the design and performance of the conventional tile are not quite satisfactory, and it has much room for improvement.

### SUMMARY OF THE INVENTION

In view of the shortcomings and drawbacks of the prior art, the present invention provides a method of manufacturing a slip-proof tiles having a surface layer and an inner layer, so as to overcome the problems of the prior art.

A major objective of the present invention is to provide a method of manufacturing slip-proof tile, wherein, mineral particles are embedded into the inner structure of a tile, such that slip-proof mineral particles are provided both inside and outside the tile structure, thus, in addition to having ordinary characteristics of slip-proof, it can also provide high wear-resistance capability, thus increasing the surface life of the slip-proof tile, and fulfilling the requirement of safe walking on the tile.

In order to achieve the above-mentioned objective, the present invention provides a method of manufacturing a slip-proof tile, comprising the following steps: firstly, stacking from bottom to top a bottom layer having a plurality of first mineral particles; a decoration layer; and an enhanced wear-resistance layer having a plurality of second mineral particles, such that the second mineral particles are exposed out of the top surface of the enhanced wear-resistance layer; then, forming a laminating wear-resistance layer having a plurality of third mineral particles on top of the enhanced wear-resistance layer, so as to embed the exposed second mineral particles, wherein, the mineral particles can be made of Al₂O₃, SiO₂, glass sand, or silicon carbide, so that the third mineral particles are distributed evenly inside and on the top surface of the laminating wear-resistance layer; and as such achieving a slip-proof tile.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a cross section view of a convention tile according to the prior art;

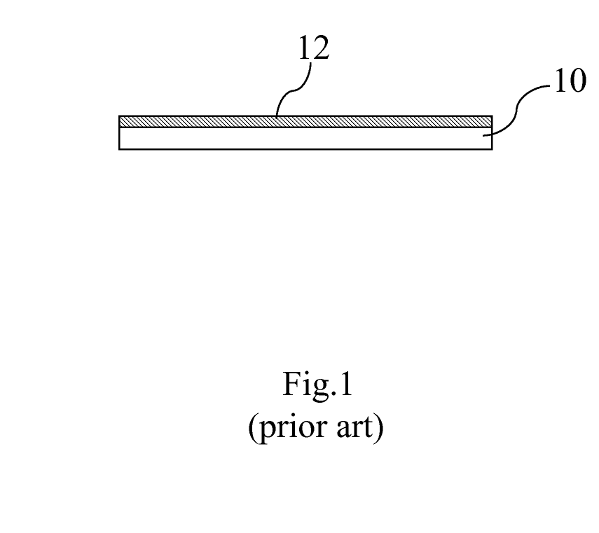

FIGS. 2(a) and 2(b) are respectively the cross section views of structures of a slip-proof tile corresponding to various steps of manufacturing the tile according to the present invention;

FIGS. 3(a) to 3(d) are respectively the cross section views of structures of an enhanced wear-resistance layer corresponding to various steps of manufacturing the layer according to the present invention; and

FIG. 4 is a flowchart of the steps of manufacturing a bottom layer according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

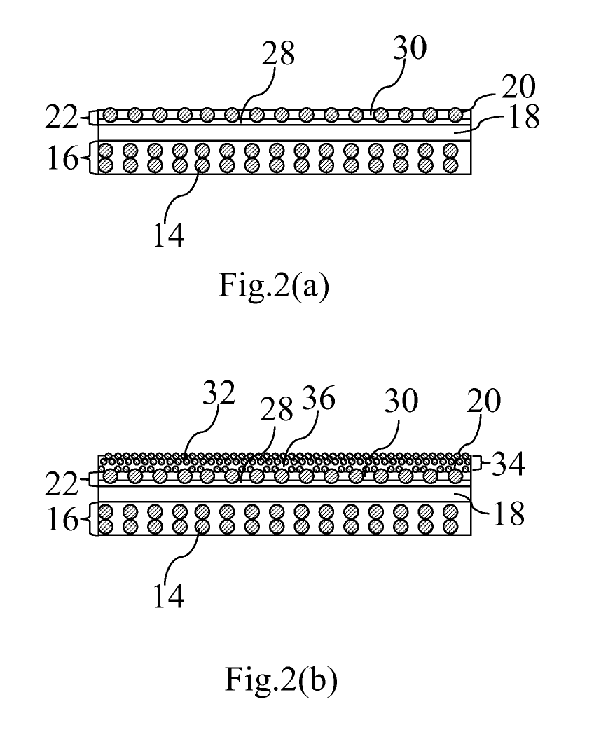

The purpose of the present invention is to provide a slip-proof tile. Refer to FIGS. 2(a) and 2(b) respectively for the cross section views of structures of a slip-proof tile corresponding to various steps of manufacturing the tile according to the present invention. As shown in FIG. 2(a), stacking from bottom to top a bottom layer 16 having a plurality of first mineral particles 14; a decoration layer 18; and an enhanced wear-resistance layer 22 having a plurality of second mineral particles 20, such that the second mineral particles 20 are exposed out of the top surface of the enhanced wear-resistance layer 22. The enhanced wear-resistance layer 22 further includes a first and second enhanced sub-wear-resistance layers 28 and 30 stacked up sequentially on the decoration layer 18, and are made of polyvinyl chloride (PVC) or transparent material, such that the second mineral particles 20 are exposed from the top surface of the second enhanced sub-wear-resistance layer 30. Then, as shown in FIG. 2(b), applying a laminating wear-resistance layer 34 having a plurality of third mineral particles 32 on the top surface of the second enhanced sub-wear-resistance layer 30 of the enhanced wear-resistance layer 22 by means of an applying rubber roller, so as to embed the exposed second mineral particles 20 into laminating wear-resistance layer 34, so that the third mineral particles 32 are distributed evenly inside and on top surface of a laminating layer 36, hereby finishing producing the tiles. The laminating wear-resistance layer 34 further includes a laminating layer 36 embedded with the third mineral particles 32, such that, the third mineral particles 32 are distributed evenly inside and on the top surface of the laminating layer 36, that can be made of ultraviolet light (UV) cured Polyurethane (PU) or transparent material. Moreover, the first, second, and third mineral particles 14, 20, 32 can be Al₂O₃ particles, SiO₂ particles, glass sand particles, or silicon carbide particles respectively. Also, the sizes of the first, second, and third mineral particles 14, 20, 32 are not subject to any specific restrictions, however, in the present invention, the diameters of the first and second mineral particles 14 and 20 are from 0.01 to 1.0 mm, the diameter of the third mineral particles 31 is from 0.01 to 0.1 mm, and diameter of the second mineral particle 20 is greater then that of the third mineral particles 32 are taken as example.

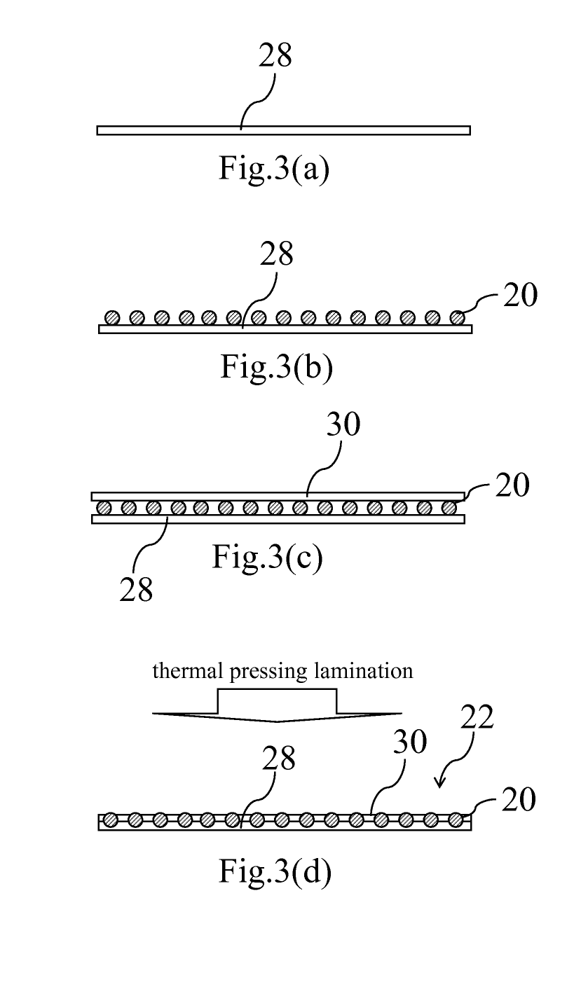

In the following, the method of manufacturing enhanced wear-resistance layer 22 is described. Refer to FIGS. 3(a) to 3(d) respectively for the cross section views of structures of an enhanced wear-resistance layer corresponding to various steps of manufacturing the layer according to the present invention. Firstly, as shown in FIG. 3(a), applying a coating on the first enhanced sub-wear-resistance layer 28, that could result in good connection and coupling between the mineral particles and polyvinyl chloride (PVC) emulsion powder or transparent material, such that the coating is composed of: PVC emulsion powder of 39˜69.5%, plasticizer of 30˜60%, and stabilizer of 0.5˜1%. Wherein, the plasticizer is di-isononyl phthalate (DINP), and the stabilizer is Ba or Zn series stabilizer.

Next, as shown in FIG. 3(b), distributing a plurality of second mineral particles 20 evenly on a first enhanced sub-wear-resistance layers 28 by means of vibration sieve device.

Then, as shown in FIG. 3(c), a second enhanced sub-wear-resistance layers 30 is placed on a plurality of second mineral particles 20, so that the plurality of second mineral particles 20 are distributed evenly between the first enhanced sub-wear-resistance layers 28 and the second enhanced sub-wear-resistance layers 30. Finally, as shown in FIG. 3(d), performing thermal press lamination for the first and second enhanced sub-wear-resistance layers 28 and 30 utilizing the coating mentioned above, to embed the second mineral particles 20 into first and second enhanced sub-wear-resistance layers 28 and 30, and also expose the second mineral particles 20 at the top surface of the second enhanced sub-wear-resistance layers 30, hereby obtaining an enhanced wear-resistance layer 22.

Due to the connection and coupling of the deeply embedded particles and specially made coating, so that the particles are not liable to be peeled off, and having high wear-resistance and scratch-resistance capabilities. In other words, the tiles thus made are not easy to be worn out, and users can be assured of long period of safe utilization.

When the outer most laminating wear-resistance layer 34 is worn out, the remaining enhanced wear-resistance layer 22 may still provide slip-proof, wear-resistance and scratch-resistance capabilities, therefore, its slip-proof effectiveness will not be reduced due to wearing out of the tile surface. In this respect, the slip-proof tile of the present invention has already passed the safety test of European Union (EU) (EN 13845 ANNEXD), thus fulfilling high standard of safe utilization.

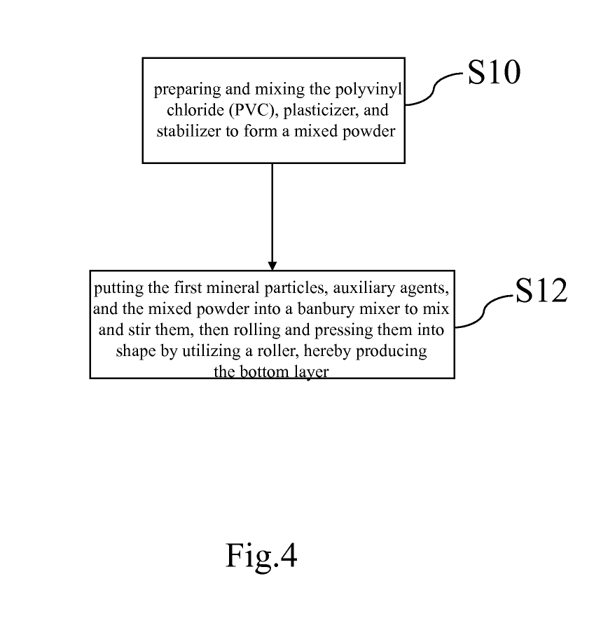

In the following, the bottom layer manufacturing method is introduced, refer to FIG. 4 for a flowchart of the steps of a method of manufacturing a bottom layer according to the present invention. Firstly, as shown in step S10, preparing and mixing the polyvinyl chloride (PVC), plasticizer, and stabilizer to form a mixed powder. Wherein, the plasticizer is di-isononyl phthalate (DINP), and the stabilizer is Ba or Zn series stabilizer, such that the mixed powder is composed of: PVC of 74.3˜69.4%, plasticizer of 24.5˜29.2%, and stabilizer of 1.2˜1.4%. Then, as shown in step S12, putting the first mineral particles, auxiliary agents, and the mixed powder into a banbury mixer to mix and stir them at 160˜170° C., then rolling and pressing them into shape by utilizing a roller, hereby producing the bottom layer required.

The data in the following table 1 is provided to prove that, for the ordinary slip-proof tile, regardless the depth of emboss of the emboss sheet applied thereon, its slip-proof, wear-resistance, scratch-resistance capabilities can not match those of the slip-proof tile of the present invention.

TABLE 1

| | ordinary slip- | slip-proof tile of the |
|---|---|---|
| | proof tile | present invention |
| slip-proof friction | 0.3 | greater than 1.0 |
| coefficient | | |
| scratch resistance | greater than 2500 g | far greater than 2500 g |
| wear resistance | less than 0.015 g | far less than 0.015 g |

From the Table 1 mentioned above, it can be known that, for the slip-proof tile of the present invention, its slip-proof, wear resistance, and scratch resistance capabilities are superior to those of the prior art.

Summing up the above, in the present invention, mineral particles are embedded into tile, so that tile may have effective slip-proof capability, thus preventing slipping and falling down of user walking thereon, hereby fulfilling safety requirements.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A slip-proof tile manufacturing method, comprising following steps:
stacking sequentially from bottom to top a bottom layer having a plurality of first mineral particles; a decoration layer; and an enhanced wear-resistance layer having a plurality of second mineral particles, such that said second mineral particles are exposed out of a top surface of said enhanced wear-resistance layer; and
forming a laminating wear-resistance layer having a plurality of third mineral particles on said top surface of said enhanced wear-resistance layer, so as to embed said exposed second mineral particles into said laminating wear-resistance layer, so that said third mineral particles are distributed evenly inside and on said top surface of said laminating wear-resistance layer.

2. The slip-proof tile manufacturing method as claimed in claim 1, wherein said step of manufacturing said enhanced wear-resistance layer comprises following steps:
applying a coating on a first enhanced sub-wear-resistance layer;
distributing said second mineral particles evenly onto said first enhanced sub-wear-resistance layer by using a vibration sieve device;
placing a second enhanced sub-wear-resistance layer on said second mineral particles; and
performing thermal pressing lamination for said first and second enhanced sub-wear-resistance layers, to embed said second mineral particles into said first and second enhanced sub-wear-resistance layers, thus exposing said second mineral particles out on said top surface of said second enhanced sub-wear-resistance layer in obtaining said enhanced wear-resistance layer.

3. The slip-proof tile manufacturing method as claimed in claim 2, wherein said first and second enhanced sub-wear-resistance layers comprise polyvinyl chloride (PVC) or transparent material.

4. The slip-proof tile manufacturing method as claimed in claim 2, wherein said coating is composed of: PVC emulsion powder of 39˜69.5%, plasticizer of 30˜60%, and stabilizer of 0.5˜1%.

5. The slip-proof tile manufacturing method as claimed in claim 4, wherein said plasticizer is a di-isononyl phthalate (DINP), and said stabilizer is a Ba or Zn series stabilizer.

6. The slip-proof tile manufacturing method as claimed in claim 1, wherein said laminating wear-resistance layer is formed through application by means of rubber wheel.

7. The slip-proof tile manufacturing method as claimed in claim 1, wherein said laminating wear-resistance layer further includes a laminating layer embedding with said third mineral particles.

8. The slip-proof tile manufacturing method as claimed in claim 7, wherein said laminating layer comprises ultraviolet light (UV) cured Polyurethane (PU) or transparent material.

9. The slip-proof tile manufacturing method as claimed in claim 1, wherein said bottom layer manufacturing step includes following steps:
mixing said polyvinyl chloride (PVC), said plasticizer, and said stabilizer to form a mixed powder; and
putting the first mineral particles, auxiliary agents, and said mixed powder into a banbury mixer to mix and stir them at 160˜170° C., then rolling and pressing them into shape by utilizing a roller, hereby producing said bottom layer required.

10. The slip-proof tile manufacturing method as claimed in claim 9, wherein said plasticizer is a di-isononyl phthalate (DINP), said stabilizer is a Ba or Zn series stabilizer, and said auxiliary agent is rosin calcium and black smoke.

11. The slip-proof tile manufacturing method as claimed in claim 9, wherein said mixed powder is composed of: said PVC of 74.3˜69.4%, said plasticizer of 24.5˜29.2%, and said stabilizer of 1.2˜1.4%.

12. The slip-proof tile manufacturing method as claimed in claim 1, wherein said first, second, and third mineral particles are Al₂O₃ particles, SiO₂ particles, glass sand particles, or silicon carbide particles.

13. The slip-proof tile manufacturing method as claimed in claim 1, wherein diameters of the first and second mineral particles and are from 0.01 to 1.0 mm, and diameter of said third mineral particles is from 0.01 to 0.10 mm.

14. The slip-proof tile manufacturing method as claimed in claim 1, wherein diameter of said second mineral particle is greater than that of said third mineral particles.
